(19) United States
(12) Patent Application Publication
(10) Pub. No.: US 2020/0130162 A1
(43) Pub. Date: Apr. 30, 2020

(54) POWER TOOL

(71) Applicant: MOBILETRON ELECTRONICS CO., LTD., Taichung City (TW)

(72) Inventors: JUI-CHEN HUANG, Taichung City (TW); SHIH-HAO WANG, Tainan City (TW)

(73) Assignee: MOBILETRON ELECTRONICS CO., LTD., Taichung City (TW)

(21) Appl. No.: 16/655,711

(22) Filed: Oct. 17, 2019

(30) Foreign Application Priority Data
Oct. 31, 2018 (TW) 107138606

(51) Int. Cl. B25F 5/00; B25B 21/02

(52) U.S. Cl. CPC B25F 5/008; B25B 21/02

(57) ABSTRACT

A power tool includes a casing having a motor receiving portion and a holding portion, a motor disposed in the motor receiving portion, a transmission disposed in the motor receiving portion, and a fan module disposed in the motor receiving portion. The holding portion is adapted to be held by a user. The motor has a rotatable shaft, a front side, and a back side opposite to the front side. The transmission is located on the front side of the motor and is connected to the rotatable shaft, and has an output shaft for being connected to a tool bit. The fan module has a driving motor and a fan blade. The driving motor is adapted to drive the fan blade to rotate. With such design, the fan module could cool the motor to remove the heat generated by the motor.

### BACKGROUND OF THE INVENTION

### Technical Field

The present invention relates generally to a power tool, and more particularly to a power tool with a good cooling effect.

### Description of Related Art

Typically, a conventional power tool includes a motor. When the motor continues to run, a temperature of the motor will continue to rise. If the motor is not effectively cooled, the components will be damaged. For instance, a circuit board is overheated to be damaged. In addition, in some applications, the conventional power tool further has a transmission connected to the motor. If the temperature of the motor continues to rise, its thermal energy will be transmitted to the transmission, so that a temperature of the transmission will also rise, and there is a risk of overheating. Therefore, how to effectively cool the motor of the power tool is one of the important problems to be solved.

In addition, in a case that if the power tool is a conventional hydraulic pulse tool with a hydraulic pulse generator for providing an impact effect, the conventional hydraulic pulse tool is disposed with the hydraulic pulse generator and a motor connected to the hydraulic pulse generator, and the hydraulic pulse generator includes a hydraulic cylinder and an output shaft connected to the hydraulic cylinder, and a rotating shaft of the motor is connected to the hydraulic pulse generator. When the rotating shaft of the motor rotates, a mechanism inside the hydraulic cylinder will be driven to rotate, so that the output shaft is driven to intermittently rotate or to produce an impact. Since the temperature of the motor will continuously rise when the motor continues in use, and the thermal energy of the motor will be transmitted to the hydraulic cylinder of the hydraulic pulse generator, so that a hydraulic oil temperature inside the hydraulic cylinder rises, thereby an oil seal will be destroyed and the hydraulic oil will be degraded. For instance, a viscosity of the hydraulic oil will decrease due to the rise of the hydraulic oil temperature, and a fluidity will change, and even cause a leakage from the oil seal, affecting a sealing degree in the hydraulic cylinder, so that the conventional hydraulic pulse tool cannot output enough impact force.

### BRIEF SUMMARY OF THE INVENTION

In view of the above, the primary objective of the present invention is to provide a power tool with a good cooling effect, which could effectively reduce a temperature of a motor, preventing the motor from overheating.

The present invention provides a power tool, which includes a casing, a motor, a transmission, and a fan module, wherein the casing has a motor receiving portion and a holding portion. The holding portion is adapted to be held by a user. The motor is disposed in the motor receiving portion and has a rotatable shaft, a front side, and a back side, wherein the front side is opposite to the back side. The transmission is disposed in the motor receiving portion, and is located on the front side of the motor, and is connected to the rotatable shaft, and has an output shaft, wherein the output shaft is adapted to be connected to a tool bit. The fan module is disposed in the motor receiving portion, and has a driving motor and a fan blade, wherein the driving motor is adapted to drive the fan blade to rotate.

With the aforementioned design, the fan module could cool the motor to remove the heat generated by the motor, thereby to prevent the motor from overheating.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the power tool according to an embodiment of the present invention;

FIG. 2 is a side view, showing the power tool according to the embodiment removes the left-half case;

FIG. 3 is a partially sectional view of the power tool shown in FIG. 1;

FIG. 4 is a block diagram of the power tool according to an embodiment of the present invention;

FIG. 5 is a side view of the power tool according to another embodiment of the present invention, showing the fan module is disposed on the top of the motor;

FIG. 6 is a side view of the power tool according to still another embodiment of the present invention, showing the fan module is disposed on the lateral of the motor; and

FIG. 7 is a side view of the power tool according to still another embodiment of the present invention, showing the fan module is disposed on the back side of the motor.

### DETAILED DESCRIPTION OF THE INVENTION

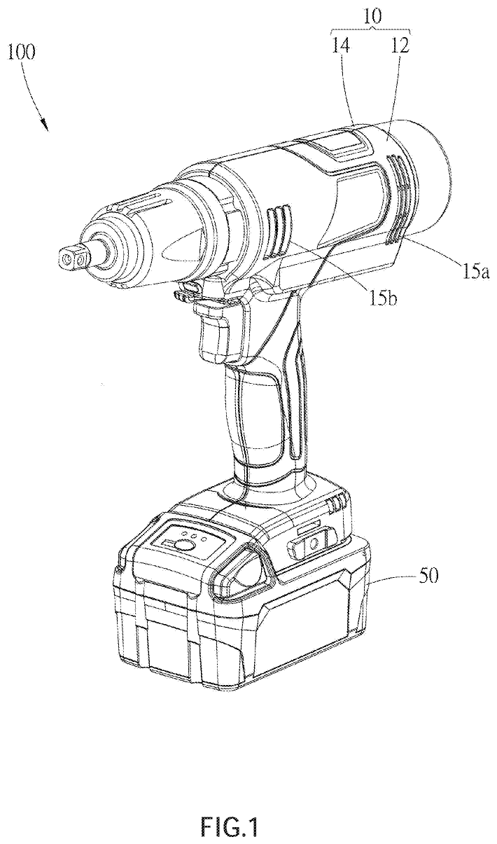

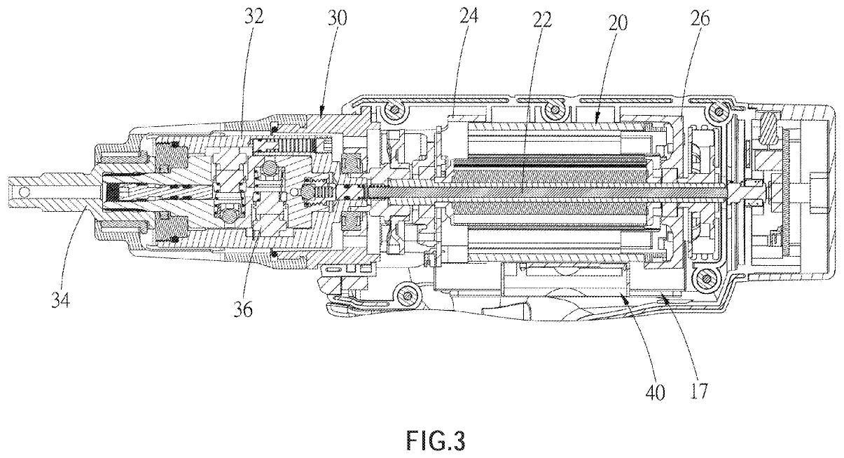

A power tool 100 according to an embodiment of the present invention is illustrated in FIG. 1 to FIG. 3, wherein the power tool 100 includes a casing 10, a motor 20, a transmission which is a hydraulic pulse generator 30 as an example, and a fan module 40.

In the current embodiment, the casing 10 includes a left-half casing 12 and a right-half casing 14, wherein the left-half casing 12 could match with the right-half casing 14 to form a receiving space for receiving the motor 20, the hydraulic pulse generator 30, and the fan module 40. In addition, a plurality of vents 15a, 15b are disposed on the casing 10, so that when the fan module 40 is in operation, an airflow could be guided into or out of the casing 10 via the vents 15a, 15b. Moreover, in the current embodiment, the casing 10 has a motor receiving portion 16 and a holding portion 18, wherein a space within the motor receiving portion 16 is adapted to receive the motor 20 and the hydraulic pulse generator 30. An outside of the holding portion 18 is adapted to be held by a user and is disposed with a trigger switch 19, wherein the trigger switch 19 is adapted to be operated (e.g. pressed) by the user to drive the motor 20 to operate. Furthermore, in the current embodiment, the power tool 100 is driven by electricity, wherein a battery box 50 for providing an electrical energy required for the operation of the power tool 100 is disposed on a bottom of the casing 10.

The motor 20 is disposed in the casing 10 and has a rotatable shaft 22, a front side, a back side, and a lateral side, wherein the front side is opposite to the back side, and the lateral side is located between the front side and the back side. For instance, the lateral side surrounds the motor 20 (or the rotatable shaft 22) in a radial direction of the motor 20. In the current embodiment, the front side of the motor 20 is connected to a front cover 24, and the back side of the motor 20 is connected to a back cover 26, wherein the front cover 24 is connected to the hydraulic pulse generator 30. In addition, a fan blade 60 is disposed on the back cover 26, and fits around the rotatable shaft 22, and is driven by the rotatable shaft 22 to rotate synchronously. However, the fan blade 60 is not a limitation of the present invention, in other embodiments, the first fan blade 60 could be omitted.

The hydraulic pulse generator 30 is disposed in the casing 10, and is located on the front side of the motor 20, and is connected to the rotatable shaft 22 of the motor 20, and has a hydraulic cylinder 32 and an output shaft 34 connected to the hydraulic cylinder 32, wherein the output shaft 34 is adapted to be connected to a tool bit (not shown). In the current embodiment, the tool bit could have a specific function such as an electric drill bit, a screwdriver bit, a wrench, a wire saw head, or other types of tool bits. However, the output shaft 34 is not a limitation of the present invention. In other embodiments, the output shaft 34 could be connected to a quick coupling first, and then the quick coupling is connected to other tool bits, so that the output shaft 34 could match with a power tool with an interchangeable tool bit. In the current embodiment, the hydraulic pulse generator 30 is a piston type hydraulic pulse device, wherein two pistons 36 are disposed inside of the hydraulic cylinder 32. An end of each of the pistons 36 is disposed with a pulley for contacting an inner wall of the hydraulic cylinder 32. When the rotatable shaft 22 drives the hydraulic cylinder 32 to rotate, the pistons 36 are intermittently actuated, thereby to drive the output shaft 34 to intermittently rotate. Since the piston type hydraulic pulse device is a conventional structure, it will not be described in detail herein.

The fan module 40 is disposed in the casing 10 and has a driving motor 42 and a fan blade 44, wherein the driving motor 42 is adapted to drive the fan blade 44 to rotate. In the current embodiment, the fan module 40 is disposed in the motor receiving portion 16 and is located on the lateral side of the motor 20. In addition, in an embodiment, the fan module 40 could be disposed on an extension line of a radial direction of the rotatable shaft 22. In the current embodiment, the motor receiving portion 16 has a receiving space 17 located between the motor 20 and the holding portion 18, wherein the fan module 40 is disposed in the receiving space 17. The fan module 40 could be driven to start, thereby to guide an airflow into or out of the casing 10 to dissipate heat and cool the motor 20. In addition, in an embodiment, on and off of the fan module 40 could be operatively coupled to the operation of the trigger switch 19. For instance, when the trigger switch 19 is pressed to drive the motor 20 to rotate, the fan module 40 is started to operate at the same time, while when the trigger switch 19 is in an unpressed state, the fan module 40 is turned off to stop operation.

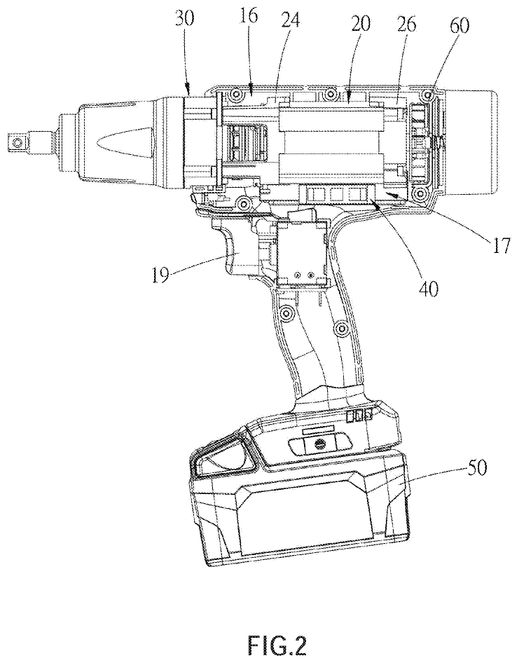

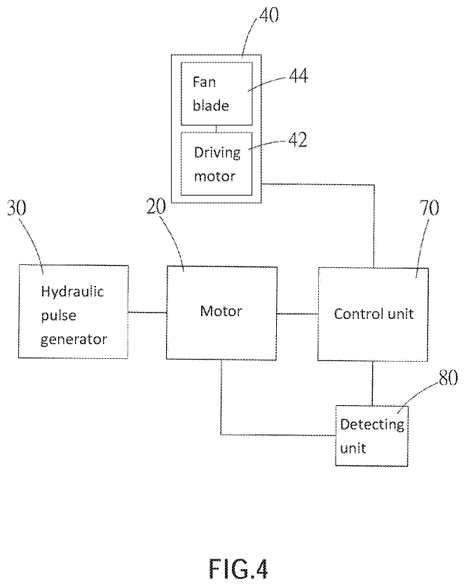

As shown in FIG. 2 and FIG. 4, in an embodiment, the power tool 100 includes a control unit 70, wherein the control unit 70 could be a micro control unit (MCU). However, the control unit 70 is not limited to be the MCU. The control unit 70 is connected to or communicates with or is electrically connected to the trigger switch 19 and the fan module 40. When the trigger switch 19 is controlled to drive the rotatable shaft 22 of the motor 20 to rotate, the control unit 70 controls the fan module 40 to operate. When the trigger switch 19 stops driving the rotatable shaft 22 to rotate, the control unit 70 continuously controls the fan module 40 to operate for a predetermined time, so that the fan module 40 could continuously cool the motor 20, wherein the predetermined time could be 5 seconds, 10 seconds, 30 seconds or other cycles, which is not a limitation of the present disclosure. In this way, the motor 20 could be cooled for the predetermined time after the motor 20 is stopped. In addition, in an embodiment, the power tool 100 further includes a detecting unit 80 which is connected to, communicates with, or is electrically connected to the control unit 70. The detecting unit 80 is adapted to detect a temperature of the motor 20. In a case that the trigger switch 19 is operated to drive the rotatable shaft 22 of the motor 20 to rotate and to drive the fan module 40 to rotate, and when the user stops operating the trigger switch 19, and when the detecting unit 80 detects the temperature of the motor 20 is higher than a first temperature, the detecting unit 80 sends a signal back to the control unit 70, so that the control unit 70 continuously drives the fan module 40 to rotate, thereby to continuously cool the motor 20. When the detecting unit 80 detects the temperature of the motor 20 is lower than a predetermined temperature (e.g. a second temperature), the detecting unit 80 sends another signal back to the control unit 70, so that the control unit 70 controls the fan module 40 to stop rotating, wherein the first temperature is higher than the second temperature. With such design, the fan module 40 could effectively cool the motor 20. For instance, in an embodiment, the first temperature could be set to 40° C., and the second temperature could be set to 30° C. However, the first temperature and the second temperature are not limited by the aforementioned design. In a use case, the control unit 70 could control the fan module 40 to be started when the motor 20 starts operating, and after the motor 20 stops running, the detecting unit 80 continuously detects whether the temperature of the motor 20 is lower than the predetermined temperature, and when the temperature of the motor 20 is still higher than the predetermined temperature, the control unit 70 controls the fan module 40 to continuously operate; the control unit 70 controls the fan module 40 to stop operating until the temperature of the motor 20 is detected to be lower than the predetermined temperature.

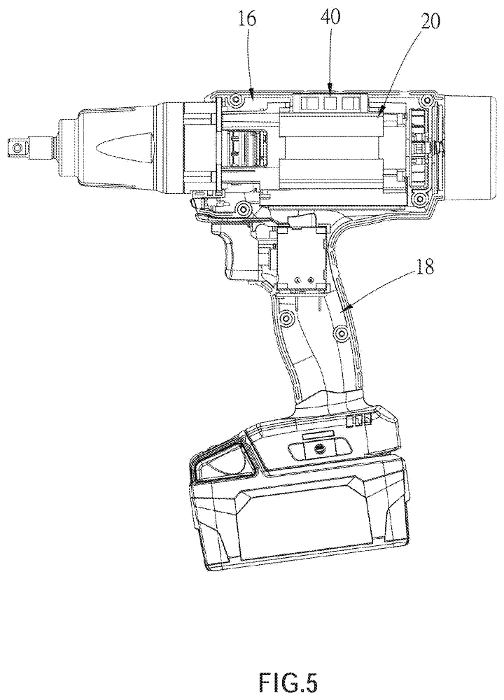

As shown in FIG. 5, in an embodiment, the fan module 40 is disposed in the motor receiving portion 16. For instance, the fan module 40 is located on a top portion of the motor 20, so that the motor 20 is located between the holding portion 18 and the fan module 40.

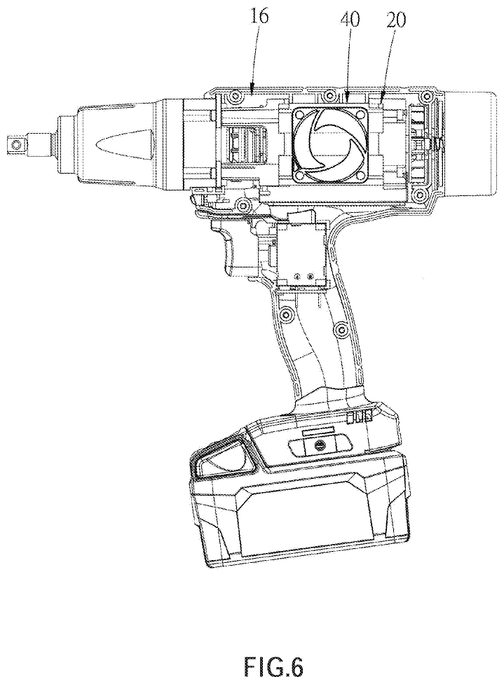

In addition, in an embodiment, the fan module 40 is disposed in the motor receiving portion 16 and is located on a left side or on a right side of the motor 20. As shown in FIG. 6, the fan module 40 is disposed upright on the left side of the motor 20.

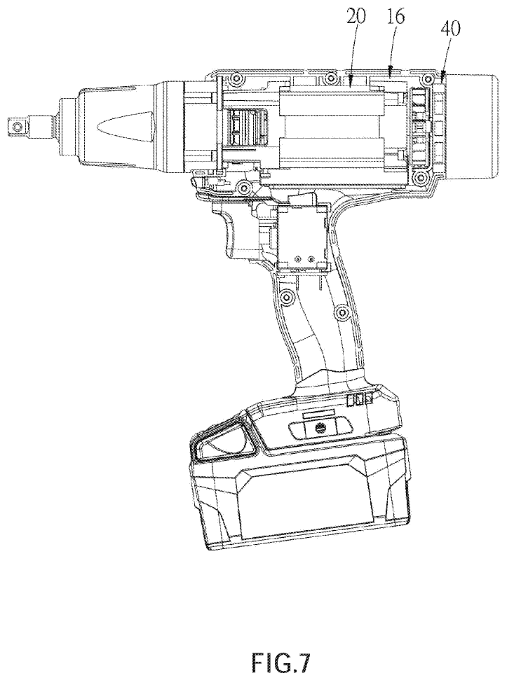

Moreover, as shown in FIG. 7, in an embodiment, the fan module 40 is disposed in the motor receiving portion 16 and is located on the back side of the motor 20. By setting the rotatable shaft 22 and fan module 40 separately, a heat dissipation effect of the power tool 100 could be further improved. No matter the motor 20 is in operation or not (i.e., no matter the rotatable shaft 22 rotates or not), the fan module 40 can operate independently to provide a good heat dissipation effect.

With the aforementioned design, the fan module 40 disposed on the lateral side of the motor 20 could cool the motor 20, thereby to effectively reduce the temperature of the motor 20, so that the motor 20 could be prevented from overheating, and could reduce an occurrence that heat transfer from the motor 20 to the transmission, thereby preventing the transmission from being overheated. For instance, the transmission of the current embodiment is the hydraulic pulse generator 30, so that the disclosure of the present invention could reduce an occurrence that heat transfer from the motor 20 to the hydraulic pulse generator 30. In this way, a hydraulic oil inside a hydraulic cylinder 32 of the hydraulic pulse generator 30 would be not easily heated by the influence of the motor 20, and the hydraulic pulse generator 30 could be ensured to operate normally.

It must be pointed out that the embodiments described above are only some preferred embodiments of the present invention. In the current embodiment, the power tool uses the hydraulic pulse generator as the transmission to be a hydraulic pulse power tool. However, the transmission of the power tool is not limited to be the hydraulic pulse generator. For instance, in other embodiments, the transmission could be but not limited to a gearbox. All equivalent structures which employ the concepts disclosed in this specification and the appended claims should fall within the scope of the present invention.

What is claimed is:

1. A power tool, comprising:
a casing having a motor receiving portion and a holding portion, wherein the holding portion is adapted to be held by a user;
a motor disposed in the motor receiving portion, wherein the motor has a rotatable shaft, a front side, and a back side; the front side is opposite to the back side; a fan blade is disposed on the back side of the motor and is connected to the rotatable shaft to be driven by the rotatable shaft to rotate synchronously;
a transmission which is disposed in the motor receiving portion, and is located on the front side of the motor, and is connected to the rotatable shaft, and has an output shaft, wherein the output shaft is adapted to be connected to a tool bit; and
a fan module disposed in the motor receiving portion, wherein the fan module has a driving motor and a fan blade; the driving motor is adapted to drive the fan blade of the fan module to rotate;
wherein the motor has a lateral side located between the front side and the back side; the fan module is located on the lateral side of the motor and is located on an extension line of a radial direction of the rotatable shaft.

2. The power tool of claim 1, wherein the fan module is located between the motor and the holding portion.

3. The power tool of claim 1, wherein the motor is located between the holding portion and the fan module.

4. The power tool of claim 1, wherein the fan module is disposed upright in the motor receiving portion.

5. The power tool of claim 1, wherein the transmission is a hydraulic pulse generator; the hydraulic pulse generator has a hydraulic cylinder connected to the output shaft.

6. The power tool of claim 1, further comprises a trigger switch and a control unit, wherein the trigger switch is adapted to be operated by the user to control the rotatable shaft of the motor to rotate; the control unit is connected to the trigger switch and the fan module; when the trigger switch is controlled to drive the rotatable shaft to rotate, the control unit controls the fan module to rotate, while when the trigger switch stops driving the rotatable shaft to rotate, the control unit continuously controls the fan module to operate for a predetermined time.

7. The power tool of claim 1, further comprises a control unit and a detecting unit, wherein the control unit is connected to the detecting unit and the fan module and is adapted to control the fan module to operate; the detecting unit is adapted to detect a temperature of the motor; when the temperature of the motor is detected to be lower than a predetermined temperature, the control unit controls the fan module to stop operating.
